(19) United States
(12) Patent Application Publication
(10) Pub. No.: US 2025/0367974 A1
(43) Pub. Date: Dec. 4, 2025

(54) WHEELED CHILDCARE DEVICE

(71) Applicant: GRACO CHILDREN'S PRODUCTS INC., Atlanta, GA (US)

(72) Inventors: Shozo MATSUSHITA, Tokyo (JP); Tomoyuki HONDA, Tokyo (JP); Hitoshi YABUUCHI, Tokyo (JP)

(73) Assignee: GRACO CHILDREN'S PRODUCTS INC., Atlanta, GA (US)

(21) Appl. No.: 19/218,134

(22) Filed: May 23, 2025

(30) Foreign Application Priority Data
May 28, 2024 (JP) 2024-086385
May 28, 2024 (JP) 2024-086386
May 28, 2024 (JP) 2024-086387
Jun. 19, 2024 (JP) 2024-098647
Sep. 2, 2024 (JP) 2024-150580
Sep. 2, 2024 (JP) 2024-150581

(51) Int. Cl. B60B 33/02; B62B 7/04

(52) U.S. Cl. CPC B60B 33/026; B62B 7/04; B62B 2301/0463

(57) ABSTRACT

A wheeled childcare device includes: a body frame; a caster mechanism including a caster holding member and a caster pivot member and configured to allow a front wheel or a rear wheel to swivel; a caster lock member configured to assume a lock position and an unlock position; a first biasing member configured to bias the caster lock member toward the lock position; and a moving member provided in the caster holding member and movable between a first position and a second position. The first position is a position in which the caster lock member is moved to the lock position, and the second position is a position in which the caster lock member is moved to the unlock position.

### CROSS-REFERENCE TO RELATED APPLICATIONS

This application claims priority to the following JP Patent Application Nos.: 2024-086387 filed May 28, 2024; 2024-086386 filed May 28, 2024; 2024-086385 filed May 28, 2024; 2024-098647 filed Jun. 19, 2024; 2024-150580 filed Sep. 2, 2024; and 2024-150581 filed Sep. 2, 2024, the entire contents of which are incorporated herein by reference.

### BACKGROUND

The present invention relates to wheeled childcare devices.

Conventionally, strollers are known that have caster wheels as their wheels and that are provided with a mechanism for unlocking the caster wheels (to permit swiveling) or locking the caster wheels (to restrict swiveling). Such a caster lock mechanism is disclosed in, for example, Japanese Unexamined Patent Application Publication No. 2020-200034.

In the configuration disclosed in Japanese Unexamined Patent Application Publication No. 2020-200034, a wheel mounting body to which a wheel is mounted is pivotable relative to a standing frame, and a lock pin is used to lock and unlock the wheel mounting body to restrict and permit swiveling of the wheel mounting body. The lock pin has an elongated shape and is slidable in its longitudinal direction within an elongated hole formed in the standing frame and the wheel mounting body. The wheel mounting body is locked (allowed to swivel) when the lock pin is in an upper position, and is unlocked (not allowed to swivel) when the lock pin is in a lower position.

### SUMMARY

In the stroller disclosed in Japanese Unexamined Patent Application Publication No. 2020-200034, the wheel mounting body is locked and unlocked by using the elongated lock pin that is movable in its longitudinal direction. Therefore, depending on the rotational position of the wheel mounting body, the elongated lock pin may contact the wall surface of the elongated hole, causing resistance between the lock pin and the wall surface of the elongated hole. As a result, locking and unlocking for swiveling may not be smoothly performed.

The present invention has been made to address such an issue, and its object is to provide a wheeled childcare device that can improve its operability.

In order to achieve the above object, a wheeled childcare device according to one aspect of the present invention includes a body frame, a caster mechanism, a cater lock member, a first biasing member, and a moving member. The body frame includes a front leg and a rear leg. The caster mechanism includes a caster holding member and a caster pivot member and is configured to allow a front wheel or a rear wheel to swivel. The caster holding member is provided at a lower end of the front leg or the rear leg. The caster pivot member is held by the caster holding member so as to be pivotable around a pivot axis extending in an up-down direction. The caster pivot member supports the front wheel or the rear wheel via a shaft. The caster lock member is provided in the caster mechanism and is configured to restrict pivoting of the caster pivot member when the caster lock member is in a lock position and to permit the pivoting of the caster pivot member when the caster lock member is in an unlock position. The first biasing member is configured to bias the caster lock member toward the lock position. The moving member is provided in the caster holding member and is movable between a first position and a second position. The first position is a position in which the caster lock member is moved to the lock position by a biasing force of the first biasing member, and the second position is a position in which the biasing force of the first biasing member is counteracted, and the caster lock member is moved to the unlock position.

Preferably, the moving member is configured to push the caster lock member to the unlock position when the moving member is in the second position.

Preferably, the wheeled childcare device further includes a second biasing member configured to bias the moving member toward the second position. A biasing force of the second biasing member is greater than the biasing force of the first biasing member.

Preferably, a biasing direction of the first biasing member is opposite to a biasing force of the second biasing member.

Preferably, the wheeled childcare device further includes an actuation mechanism connected to the moving member and configured to actuate the moving member to switch between a first state and a second state. The first state corresponds to the lock position of the caster lock member, and the second state corresponds to the unlock position of the caster lock member.

Preferably, the wheeled childcare device further includes a connecting member connecting the moving member and the actuation mechanism.

Preferably, the body frame further includes a push bar, and the actuation mechanism includes an operation mechanism provided on the push bar and configured to operate the moving member to switch the moving member from the first state to the second state.

Preferably, the actuation mechanism includes a displacement member provided on the body frame and connected to the moving member via the connecting member. The displacement member is configured to be displaced between the first state and the second state.

Preferably, the actuation mechanism further includes a third biasing member configured to bias the displacement member toward the first state. A biasing force of the third biasing member is greater than the biasing force of the second biasing member.

Preferably, the body frame further includes a push bar, and the actuation mechanism includes an operation mechanism provided on the push bar and configured to operate the displacement member to switch the displacement member from the first state to the second state.

Preferably, the operation mechanism includes an operation member and a drive member. The drive member is connected to the operation member and is configured to be switched between the first state and the second state by an operating force of the operation member.

The wheeled childcare device of the present invention can improve its operability.

### BRIEF DESCRIPTION OF THE DRAWINGS

FIG. 1 shows side views of a stroller according to a first embodiment of the present invention, where FIG. 1(A) shows a push bar in a front-facing position, and FIG. 1(B) shows the push bar in a rear-facing position.

FIG. 2 schematically shows the internal structure of the stroller of the first embodiment, illustrating a state in which an operation mechanism is not operated in a front-facing mode.

FIG. 3 schematically shows the internal structure of the stroller of the first embodiment, illustrating a state in which the operation mechanism is operated in the front-facing mode.

FIG. 4 schematically shows the internal structure of a caster mechanism, where FIG. 4(A) shows a lock state and FIG. 4(B) shows an unlock state.

FIG. 5 shows schematic enlarged views illustrating the internal structure of components around a push bar, where FIG. 5(A) is a view corresponding to FIG. 2 and illustrating a first state, and FIG. 5(B) is a view corresponding to FIG. 3 and illustrating a second state.

FIG. 6 shows schematic enlarged views illustrating the internal structure of an operation mechanism, where FIG. 6(A) is a view corresponding to FIG. 2 and illustrating a first state, and FIG. 6(B) is a view corresponding to FIG. 3 and illustrating a second state.

FIG. 7 schematically shows the internal structure of the stroller of the first embodiment, illustrating a state in which the operation mechanism is not operated in a rear-facing mode.

FIG. 8 schematically shows the internal structure of the stroller of the first embodiment, illustrating a state in which the operation mechanism is operated in the rear-facing mode.

FIG. 9 schematically shows the internal structure of a stroller according to a second embodiment of the present invention, illustrating a state in which an operation mechanism is not operated in the front-facing mode.

FIG. 10 schematically shows the internal structure of the stroller of the second embodiment, illustrating a state in which the operation mechanism is operated in the front-facing mode.

FIG. 11 schematically shows the internal structure of a stroller according to a third embodiment of the present invention, illustrating a state in which an operation mechanism is not operated.

FIG. 12 schematically shows the internal structure of the stroller of the third embodiment, illustrating a state in which the operation mechanism is operated.

FIG. 13 schematically shows the internal structure of components around a push bar, where FIG. 13(A) is a view corresponding to FIG. 11 and illustrating a first state, and FIG. 13(B) is a view corresponding to FIG. 12 and illustrating a second state.

FIG. 14 schematically shows the internal structure of a stroller according to a fourth embodiment of the present invention, illustrating a state in which an operation mechanism is not operated.

FIG. 15 schematically shows the internal structure of the stroller of the fourth embodiment, illustrating a state in which the operation mechanism is operated.

FIG. 16 schematically shows the internal structure of a stroller according to a fifth embodiment of the present invention, illustrating a state in which a displacement member is not operated.

FIG. 17 schematically shows the internal structure of the stroller of the fifth embodiment, illustrating a state in which the displacement member is operated.

FIG. 18 schematically shows the internal structure of a caster mechanism of a stroller according to a sixth embodiment of the present invention, where FIG. 18(A) shows a lock position and FIG. 18(B) shows an unlock position.

### DETAILED DESCRIPTION

Embodiments of the present invention will be described in detail with reference to the drawings. The same or corresponding portions are denoted by the same signs throughout the drawings, and description thereof will not be repeated.

### First Embodiment

### Configurations

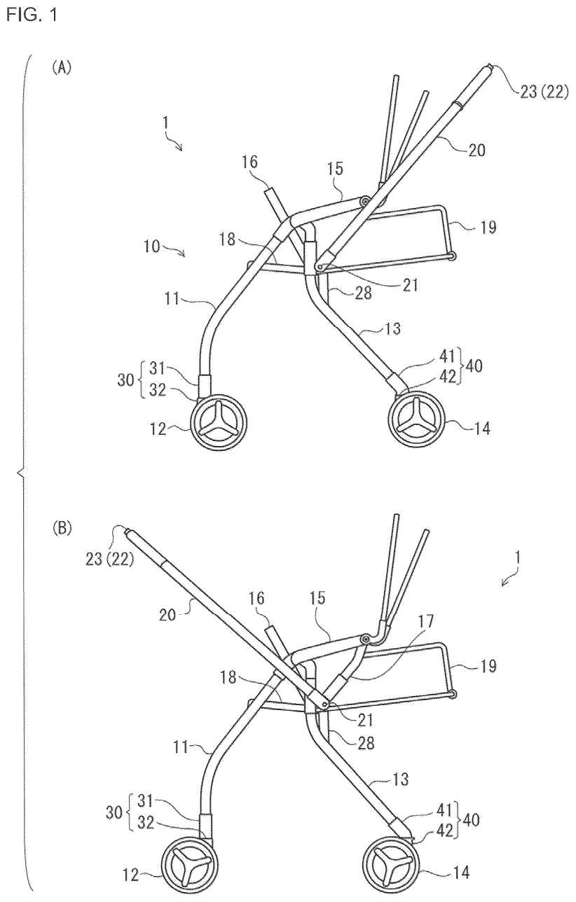

An overview of a stroller 1 according to a first embodiment will be described with reference to FIGS. 1(A) and 1(B). FIG. 1(A) shows a push bar in a front-facing position (infant/toddler facing forward). FIG. 1(B) shows the push bar in a rear-facing position (infant/toddler facing rearward). To facilitate understanding of the invention, these figures mainly show a body frame of a reversible stroller, and do not show components such as an infant/toddler seat. In the following description, the front-rear direction refers to the front-rear direction of the stroller, and the left-right direction refers to the left-right direction when viewed from the front of the stroller.

The stroller 1 of the present embodiment includes, as a body frame 10, a pair of front legs 11, a pair of rear legs 13, an armrest 15, an armrest support member 17, a seat support member 18, a backrest support member 19, and a push bar 20. The components of the body frame 10 other than the seat support member 18, the backrest support member 19, and the push bar 20 are provided in pairs on the right and left sides such that the components of each pair are separated from each other in the width direction (stroller width direction).

A front-wheel caster mechanism 30 is provided at the lower end of each front leg 11 extending in the up-down direction. A front wheel 12 is provided at the lower end of each front leg 11 with the front-wheel caster mechanism 30 interposed therebetween. A rear-wheel caster mechanism 40 is provided at the lower end of each rear leg 13 located behind each front leg 11 and extending in the up-down direction. A rear wheel 14 is provided at the lower end of each rear leg 11 with the rear-wheel caster mechanism 40 interposed therebetween. The front-wheel caster mechanism 30 and the rear-wheel caster mechanism 40 will be described later.

The upper end of the front leg 11 is pivotally connected to the front end of the armrest 15 extending in the front-rear direction of the stroller 1. The upper end of the rear leg 13 is pivotally connected to a front-end portion of the armrest 15 at a position behind the upper end of the front leg 11. As shown in FIG. 1(B), the rear end of the armrest 15 is pivotally connected via a pivot shaft to the upper end of the armrest support member 17 extending in the up-down direction. Specifically, the rear end of the armrest 15 and the upper end of the armrest support member 17 are also connected to canopy ribs via the pivot shaft.

The seat support member 18 is disposed below the armrest 15. The front end of the seat support member 18 is connected to the middle portions of the front legs 11. The rear end of the seat support member 18 is pivotally connected to the lower end of the push bar 20, the upper ends of reversal brackets 28, and the lower ends of the armrest support members 17 via swing shafts 21. A front guard 16 extending in the width direction is disposed above the seat support member 18.

The rear end of the seat support member 18 is pivotally connected to the lower end of the backrest support member 19 at a position different from the swing shafts 21. The seat support member 18 supports an infant/toddler seating portion from below, and the backrest support member 19 supports an infant/toddler backrest portion from below. Although not shown in the figures, a hammock is suspended across the seat support member 18 and the backrest support member 19, and a cushion is attached to the hammock. A seat surface forming a seat portion is thus formed over the seat support member 18, and the seat support member 18 supports the seat surface from below.

The push bar 20 has, for example, an inverted U-shape. The push bar 20 is swingable in the front-rear direction relative to the body frame 10 via the swing shafts 21 and is switchable between the front-facing position (FIG. 1(A)) and the rear-facing position (FIG. 1(B)). Specifically, the lower end of the push bar 20 is pivotally connected to the lower ends of the armrest support members 17 described later via the swing shafts 21. Each swing shaft 21 is disposed adjacent to a corresponding rear leg 13. An operation mechanism 22 is provided at the upper end of the push bar 20. The operation mechanism 22 will also be described later.

As shown in FIG. 1(B), the armrest support member 17 is a member extending in the up-down direction. The upper end of the armrest support member 17 is pivotally connected to the rear end of the armrest 15 and the two canopy ribs via the pivot shaft. The lower end of the armrest support member 17 is pivotally connected to the lower end of the push bar 20, the upper end of the reversal bracket 28, and the rear end of the seat support member 18 via the swing shaft 21. Although not shown in the figures, a plurality of auxiliary canopy ribs is arranged between the canopy ribs, and a canopy fabric is stretched between the canopy ribs.

The lower end of the armrest support member 17 is switchable between a position where the armrest support member 17 is locked relative to the rear leg 13 and a position where the armrest support member 17 is unlocked from the rear leg 13. The position where the armrest support member 17 is locked relative to the rear leg 13 corresponds to a traveling state shown in FIGS. 1(A) and 1(B). This position is the position where the lower end of the armrest support member 17 and the middle portion of the rear leg 13 are in contact with each other.

The position where the armrest support member 17 is unlocked from the rear leg 13 corresponds to a folded state, not shown. This position is the position where the lower end of the armrest support member 17 and the lower end of the rear leg 13 are in contact with each other. Specifically, a lock portion (not shown) that can lock the armrest support member 17 relative to the rear leg 13 is provided at the lower end of the armrest support member 17. The armrest support member 17 can be unlocked from the rear leg 13 by unlocking the lock portion. This configuration allows the stroller 1 to be folded. The lock portion may be provided at the upper end of the reversal bracket 28.

In the stroller 1 described above, both the front wheels 12 and the rear wheels 14 are caster wheels. In a normal state where the operation mechanism 22 is not operated, the front wheels in the direction of travel are unlocked (allowed to swivel), while the rear wheels in the direction of travel are locked (not allowed to swivel). In an operating state in which the operation mechanism 22 is operated, all of the wheels 12, 14 are unlocked (allowed to swivel). The state in which all of the wheels 12, 14 are allowed to swivel is sometimes referred to as the “drift state.”

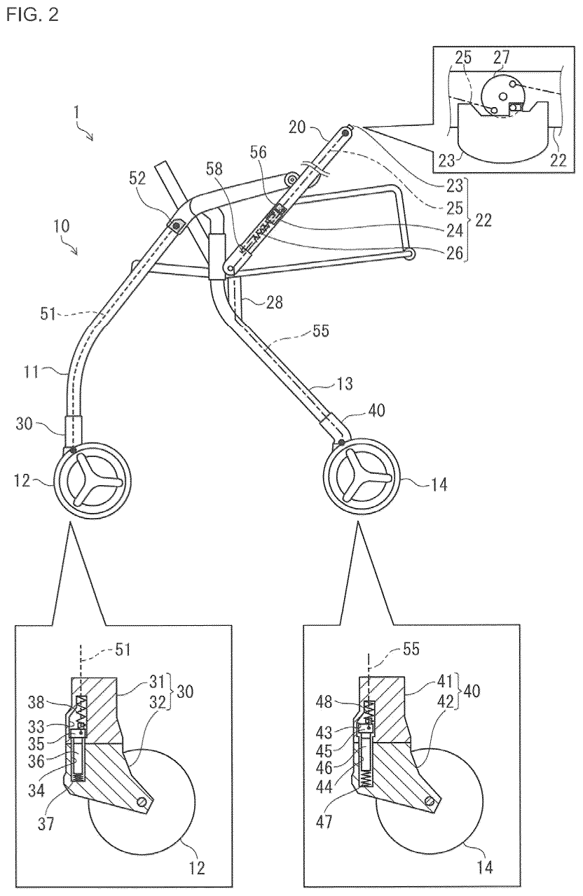

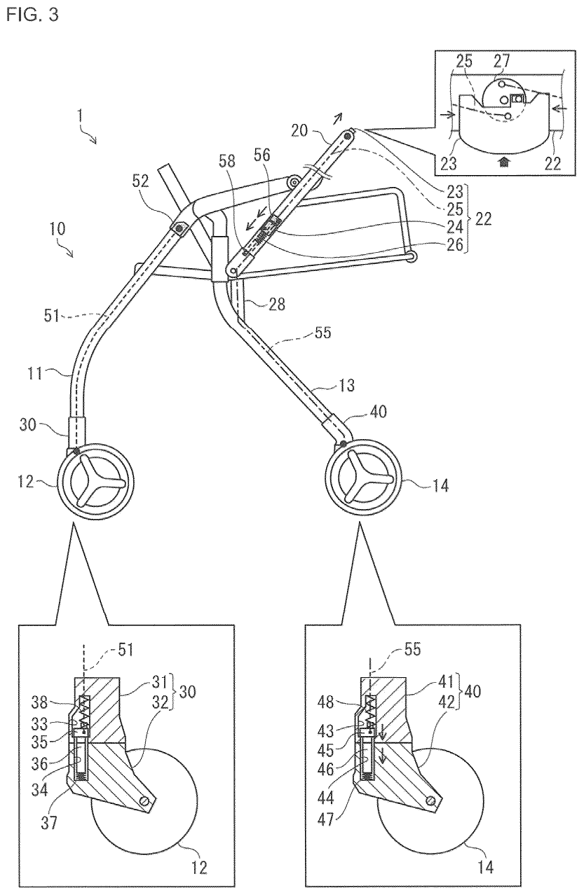

A structure for unlocking and locking the wheels 12, 14 will be described in detail with further reference to FIGS. 2 to 6. To facilitate understanding, the internal structures around the wheels 12, 14 and the internal mechanism of the operation mechanism 22 are shown in enlarged views in FIGS. 2 and 3. In FIGS. 2, 3, and 5, displacement members 52, 56 and a drive member 24 are shown shaded, and connecting members 25, 51, and 55 are shown by lines different from solid lines (long dashed double-short dashed line, dashed line, and long dashed short dashed line) for better understanding.

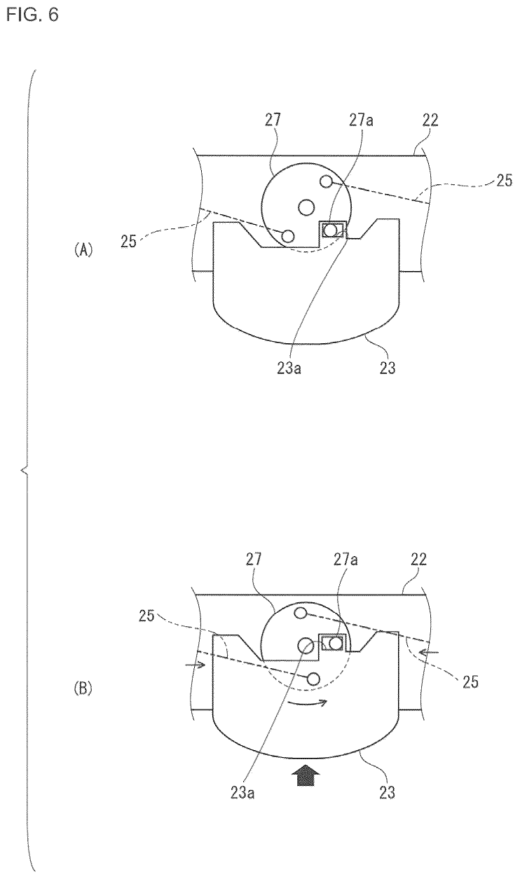

The same applies to FIG. 6 and the subsequent figures.

As described above, the front-wheel caster mechanism 30 is a mechanism that allows the front wheel 12 to swivel. The front-wheel caster mechanism 30 is provided at the lower end of the front leg 11 and includes a front-wheel caster holding member 31 and a front-wheel caster pivot member 32. The front-wheel caster holding member 31 is fixed to the lower end of the front leg 11, and the front-wheel caster pivot member 32 is disposed under the front-wheel caster holding member 31. The front-wheel caster pivot member 32 is held by the front-wheel caster holding member 31 so as to be pivotable around a pivot axis extending in the up-down direction. The front-wheel caster pivot member 32 supports the front wheel 12 via a shaft.

The rear-wheel caster mechanism 40 is a mechanism that allows the rear wheel 14 to swivel. Like the front-wheel caster mechanism 30, the rear-wheel caster mechanism 40 includes a rear-wheel caster holding member 41 and a rear-wheel caster pivot member 42. The rear-wheel caster holding member 41 is fixed to the lower end of the rear leg 13. The rear-wheel caster pivot member 42 is held by the rear-wheel caster holding member 41 so as to be pivotable around a pivot axis extending in the up-down direction. The rear-wheel caster pivot member 42 supports the rear wheel 13 via a shaft. With this configuration, the rear-wheel caster mechanism 40 allows the rear wheel 14 to swivel.

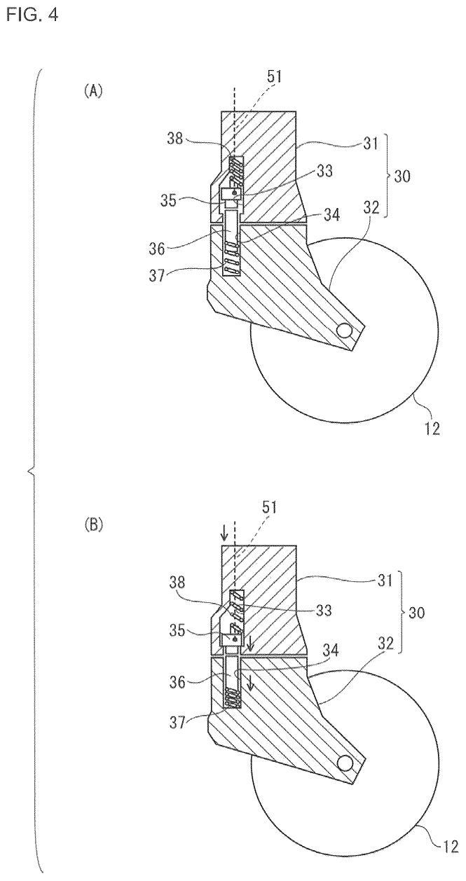

As shown in FIG. 4(A), the front-wheel caster holding member 31 is provided with a front-wheel first hole 33, a front-wheel moving member 35, and a front-wheel second biasing member 38. The front-wheel caster pivot member 32 is provided with a front-wheel second hole 34, a front-wheel caster lock mechanism 36, and a front-wheel first biasing member 37.

The front-wheel first hole 33 and the front-wheel second hole 34 have substantially the same diameter. The front-wheel first hole 33 and the front-wheel second hole 34 connect together in the up-down direction to form an elongated hole extending in the up-down direction. The front-wheel moving member 35 is connected to the front-wheel connecting member 51 described later and moves with displacement of the front-wheel-side displacement member 52 (FIG. 2) connected to the front-wheel connecting member 51. This operation will be described later. The front-wheel moving member 35 is located in the front-wheel first hole 33 and is movable between a first position (upper position: FIG. 4(A)) and a second position (lower position: FIG. 4(B)) inside the front-wheel first hole 33. The front-wheel moving member 35 does not move in the front-wheel second hole 34. The front-wheel second biasing member 38 is, for example, a spring, and biases the front-wheel moving member 35 downward. Specifically, the front-wheel second biasing member 38 is disposed between the front-wheel first hole 33 and the upper end of the front-wheel moving member 35.

The front-wheel caster lock member 36 is displaceable between a lock position (FIG. 4(A)) and an unlock position (FIG. 4(B)). When in the lock position, the front-wheel caster lock member 36 extends in both the front-wheel first hole 33 and the front-wheel second hole 34. When in the unlocked position, the front-wheel caster lock member 36 extends only in the front-wheel second hole 34. Specifically, the front-wheel caster lock member 36 is movable up and down in the front-wheel first hole 33 and the front-wheel second hole 34. The front-wheel caster lock member 36 is, for example, a pin extending in the up-down direction. The size of the front-wheel caster lock member 36 is set to be smaller than the inner diameters of the front-wheel first hole 33 and the front-wheel second hole 34 so that the front-wheel caster lock member 36 can slide inside the front-wheel first hole 33 and the front-wheel second hole 34. The upper end of the front-wheel caster lock member 36 is in contact with the lower end of the front-wheel moving member 35.

The front-wheel first biasing member 37 is, for example, a spring, and biases the front-wheel caster lock member 36 upward toward the lock position. Specifically, the front-wheel first biasing member 37 is disposed between the front-wheel second hole 34 and the lower end of the front-wheel caster lock member 36.

As described above, the biasing direction of the front-wheel first biasing member 37 is upward, the biasing direction of the front-wheel second biasing member 38 is downward. In other words, their biasing directions are opposite. However, the biasing force of the front-wheel first biasing member 37 is set to be smaller than the biasing force of the front-wheel second biasing member 38. Therefore, when no force is applied from the front-wheel connecting member 51 to the front-wheel moving member 35 (e.g., when the front-wheel connecting member 51 is loosened), the biasing force of the front-wheel first biasing member 37 is counteracted, and the front-wheel caster lock member 36 is moved to the unlock position (FIG. 4(B)). Specifically, the front-wheel moving member 35 pushes the front-wheel caster lock member 36 to the unlock position, namely the lower position.

When a force is applied from the front-wheel connecting member 51 to the front-wheel moving member 35 (e.g., when the front-wheel connecting member 51 is pulled), the biasing force of the front-wheel second biasing member 38 is counteracted, and the front-wheel caster lock member 36 is moved to the lock position (FIG. 4(A)) by the biasing force of the front-wheel first biasing member 37. Specifically, since the front-wheel moving member 35 is moved upward without pushing the front-wheel caster lock member 36, the front-wheel caster lock member 36 is moved to the lock position, namely the upper position. The expression “the biasing force of the front-wheel first biasing member 37 or the front-wheel second biasing member 38 is counteracted” is intended to include not only the biasing force of the front-wheel first biasing member 37 or the front-wheel second biasing member 38 being fully overcome but also the biasing force of the front-wheel first biasing member 37 or the front-wheel second biasing member 38 being reduced by a certain amount.

The front-wheel caster lock member 36 is not connected to the front-wheel moving member 35 and is merely in contact with the front-wheel moving member 35. Therefore, as shown in FIG. 4(A), when the front-wheel caster lock member 36 is positioned so as to extend across the boundary between the front-wheel caster holding member 31 and the front-wheel caster pivot member 32, the front-wheel caster lock member 36 is in the lock position (restricts pivoting of the front-wheel caster pivot member 32 about its pivot axis). As shown in FIG. 4(B), when the front-wheel caster lock member 36 is positioned such that its upper end and the lower end of the front-wheel moving member 35 align with the boundary between the front-wheel caster holding member 31 and the front-wheel caster pivot member 32, the front-wheel caster lock member 36 is in the unlock position (permits pivoting of the front-wheel caster pivot member 32 about its pivot axis).

As an example, the front-wheel first biasing member 37 is disposed between the front-wheel second hole 34 and the lower end of the front-wheel caster lock member 36. However, the position of the front-wheel first biasing member 37, the type of the spring, etc. are not limited to the illustrated example as long as the front-wheel first biasing member 37 biases the front-wheel caster lock member 36 toward the lock position. The same applies to the front-wheel second biasing member 38. As an example, the front-wheel second biasing member 38 is disposed between the front-wheel first hole 33 and the upper end of the front-wheel moving member 35. However, the position of the front-wheel second biasing member 38, the type of the spring, etc. are not limited to the illustrated example as long as the front-wheel second biasing member 38 biases the front-wheel moving member 35 toward the second position (lower position).

As shown in FIGS. 2 and 3, the rear wheel caster holding member 41 is provided with a rear-wheel first hole 43, a rear-wheel moving member 45, and a rear-wheel second biasing member 48. The rear-wheel caster pivot member 42 is provided with a rear-wheel second hole 44, a rear-wheel caster lock member 46, and a rear-wheel first biasing member 47.

The rear-wheel first hole 43 and the rear-wheel second hole 44 have substantially the same diameter. The rear-wheel first hole 43 and the rear-wheel second hole 44 connect together in the up-down direction to form an elongated hole extending in the up-down direction. The rear-wheel moving member 45 is connected to the rear-wheel connecting member 55 described later and moves with displacement of the rear-wheel-side displacement member 56 connected to the rear-wheel connecting member 55. This operation will be described later. The rear-wheel moving member 45 is located in the rear-wheel first hole 43 and is movable between a first position (upper position: FIG. 2) and a second position (lower position: FIG. 3) inside the rear-wheel first hole 43. The rear-wheel moving member 45 does not move in the rear-wheel second hole 44. The rear-wheel second biasing member 48 is, for example, a spring, and biases the rear-wheel moving member 45 downward. Specifically, the rear-wheel second biasing member 48 is disposed between the rear-wheel first hole 43 and the upper end of the rear-wheel moving member 45.

The rear-wheel caster lock member 46 is displaceable between a lock position (FIG. 2) and an unlock position (FIG. 3). When in the lock position, the rear-wheel caster lock member 46 extends in both the rear-wheel first hole 43 and the rear-wheel second hole 44. When in the unlocked position, the rear-wheel caster lock member 46 extends only in the rear-wheel second hole 44. Specifically, the rear-wheel caster lock member 46 is movable up and down in the rear-wheel first hole 43 and the rear-wheel second hole 44. The rear-wheel caster lock member 46 is, for example, a pin extending in the up-down direction. The size of the rear-wheel caster lock member 46 is set to be smaller than the inner diameters of the rear-wheel first hole 43 and the rear-wheel second hole 44 so that the rear-wheel caster lock member 46 can slide inside the rear-wheel first hole 43 and the rear-wheel second hole 44. The upper end of the rear-wheel caster lock member 46 is in contact with the lower end of the rear-wheel moving member 45.

The rear-wheel first biasing member 47 is, for example, a spring, and biases the rear-wheel caster lock member 46 upward. Specifically, the rear-wheel first biasing member 47 is disposed between the rear-wheel second hole 44 and the lower end of the rear-wheel caster lock member 46.

As described above, the biasing direction of the rear-wheel first biasing member 47 is upward, the biasing direction of the rear-wheel second biasing member 48 is downward. In other words, their biasing directions are opposite. However, the biasing force of the rear-wheel first biasing member 47 is set to be smaller than the biasing force of the rear-wheel second biasing member 48. Therefore, when no force is applied from the rear-wheel connecting member 55 to the rear-wheel moving member 45 (e.g., when the rear-wheel connecting member 55 is loosened), the biasing force of the rear-wheel first biasing member 47 is counteracted, and the rear-wheel caster lock member 46 is moved to the unlock position (FIG. 3). Specifically, the rear-wheel moving member 45 pushes the rear-wheel caster lock member 46 to the unlock position, namely the lower position.

When a force is applied from the rear-wheel connecting member 55 to the rear-wheel moving member 45 (e.g., when the rear-wheel connecting member 51 is pulled), the biasing force of the rear-wheel second biasing member 48 is counteracted, and the rear-wheel caster lock member 46 is moved to the lock position (FIG. 2) by the biasing force of the rear-wheel first biasing member 47. Specifically, since the rear-wheel moving member 45 is moved upward without pushing the rear-wheel caster lock member 46, the rear-wheel caster lock member 46 is moved to the lock position, namely the upper position. The expression “the biasing force of the rear-wheel first biasing member 47 or the rear-wheel second biasing member 48 is counteracted” is intended to include not only the biasing force of the rear-wheel first biasing member 47 or the rear-wheel second biasing member 48 being fully overcome but also the biasing force of the rear-wheel first biasing member 47 or the rear-wheel second biasing member 48 being reduced by a certain amount.

The rear-wheel caster lock member 46 is not connected to the rear-wheel moving member 45 and is merely in contact with the rear-wheel moving member 45. Therefore, as shown in FIG. 2, when the rear-wheel caster lock member 46 is positioned so as to extend across the boundary between the rear-wheel caster holding member 41 and the rear-wheel caster pivot member 42, the rear-wheel caster lock member 46 is in the lock position (restricts pivoting of the rear-wheel caster pivot member 42 about its pivot axis). As shown in FIG. 3, when the rear-wheel caster lock member 46 is positioned such that its upper end and the lower end of the rear-wheel moving member 45 align with the boundary between the rear-wheel caster holding member 41 and the rear-wheel caster pivot member 42, the rear-wheel caster lock member 46 is in the unlock position (permits pivoting of the rear-wheel caster pivot member 42 about its pivot axis).

Like the biasing member 37 for the front wheel 12, the rear-wheel first biasing member 47 is disposed between the rear-wheel second hole 44 and the lower end of the rear-wheel caster lock member 46 as an example. However, the position of the rear-wheel first biasing member 47, the type of the spring, etc. are not limited to the illustrated example as long as the rear-wheel first biasing member 47 biases the rear-wheel caster lock member 46 toward the lock position. The same applies to the rear-wheel second biasing member 48. Like the biasing member 38 for the front wheel 12, the rear-wheel second biasing member 48 is disposed between the rear-wheel first hole 43 and the upper end of the rear-wheel moving member 45 as an example. However, the position of the rear-wheel second biasing member 48, the type of the spring, etc. are not limited to the illustrated example as long as the rear-wheel second biasing member 48 biases the rear-wheel moving member 45 toward the second position (lower position).

As shown in FIG. 2, the front-wheel connecting member 51 and the rear-wheel connecting member 55 are displaceably mounted in the body frame 10. The front-wheel connecting member 51 and the rear-wheel connecting member 55 are bendable elongated metal members such as wires. The front-wheel connecting member 51 is passed through the tubular front leg 11. One end of the front-wheel connecting member 51 is coupled to the front-wheel moving member 35 inside the front-wheel caster holding member 31. The other end of the front-wheel connecting member 51 is coupled to the front-wheel-side displacement member 52 inside the front leg 11.

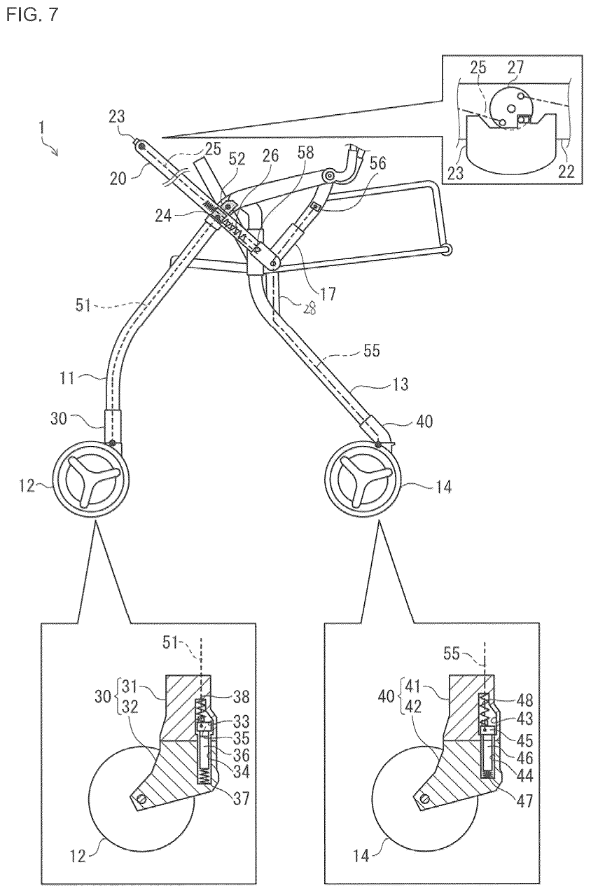

As shown particularly in FIG. 7, the rear-wheel connecting member 55 is sequentially passed through the tubular rear leg 13, the reversal bracket 28, and the armrest support member 17. One end of the rear-wheel connecting member 55 is coupled to the rear-wheel moving member 45 inside the rear-wheel caster holding member 41. The other end of the rear-wheel connecting member 55 is coupled to the rear-wheel-side displacement member 56 inside the rear leg 13.

As shown in FIG. 2, the front-wheel-side displacement member 52 is connected to the front-wheel moving member 35 via the front-wheel connecting member 51, as described above. The front-wheel-side displacement member 52 is displaced from a second state to a first state when the push bar 20 is switched from the front-facing position to the rear-facing position. The second state corresponds to the unlock position (lower position: FIGS. 2, 3) of the front-wheel caster lock member 36, and the first state corresponds to the lock position (upper position: FIG. 7) of the front-wheel caster lock member 36. The front-wheel-side displacement member 52 is also displaced between the first state and the second state by operating the operation mechanism 22 when in the rear-facing position.

The front-wheel-side displacement member 52 is movable up and down along the body frame 10, specifically, at least along the front leg 11. The front-wheel-side displacement member 52 is a member that moves up and down along the outer periphery of the tubular front leg 11. The specific shape of the front-wheel-side displacement member 52 is not limited. The front-wheel-side displacement member 52 may have any shape as long as it is coupled to at least the front-wheel connecting member 51 and transmits its own displacement to the front-wheel moving member 35. From the perspective of improving operation stability, the front-wheel-side displacement member 52 may be provided with a biasing member, such as a spring, that biases the front-wheel-side displacement member 52 downward.

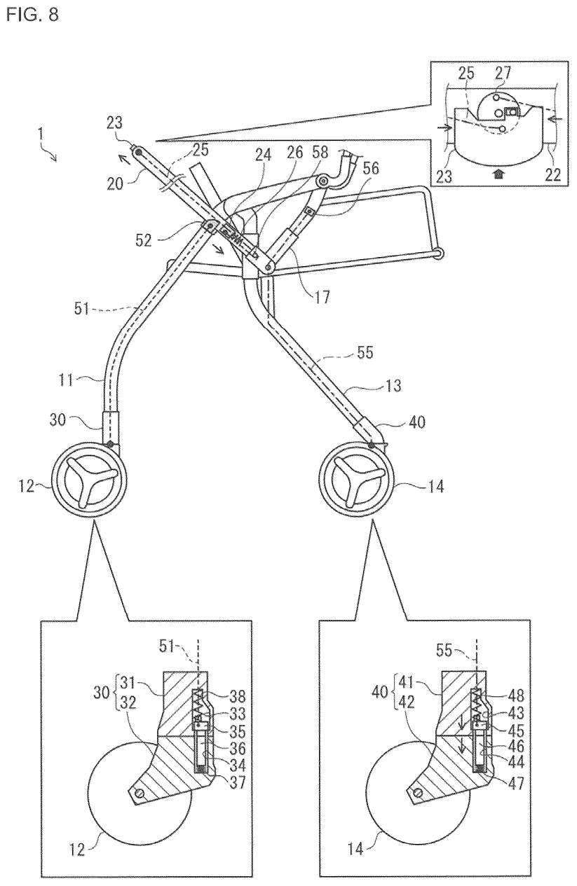

As described above, the rear-wheel-side displacement member 56 is connected to the rear-wheel moving member 45 via the rear-wheel connecting member 55. The rear-wheel-side displacement member 56 is displaced from a second state to a first state when the push bar 20 is switched from the rear-facing position to the front-facing position. The second state corresponds to the unlock position (lower position: FIGS. 7, 8) of the rear-wheel caster lock member 46, and the first state corresponds to the lock position (upper position: FIG. 2) of the rear-wheel caster lock member 46. The rear-wheel-side displacement member 56 is also displaced between the first state and the second state by operating the operation mechanism 22 when in the front-facing position.

As shown in FIG. 7, the rear-wheel-side displacement member 56 is movable up and down along the body frame 10, specifically, along the armrest support member 17. The rear-wheel-side displacement member 56 is a member that moves up and down along the outer periphery of the tubular armrest support member 17. The specific shape of the rear-wheel-side displacement member 56 is not limited. The rear-wheel-side displacement member 56 may have any shape as long as it is coupled to at least the rear-wheel connecting member 55 and transmits its own displacement to the rear-wheel moving member 45. The rear-wheel-side displacement member 56 is provided on the body frame 10 at a position separated from the front-wheel-side displacement member 52. Specifically, the front-wheel-side displacement member 52 is provided on the front leg 11, and the rear-wheel-side displacement member 56 is provided on the armrest support member 17 on the rear leg 13 side. The front-wheel-side displacement member 52 and the rear-wheel-side displacement member 56 are thus substantially spaced apart from each other. However, the front-wheel-side displacement member 52 and the rear-wheel-side displacement member 56 may be positioned in any manner as long as they are not coupled to each other. The front-wheel-side displacement member 52 and the rear-wheel-side displacement member 56 may be disposed close to each other or may be in contact with each other.

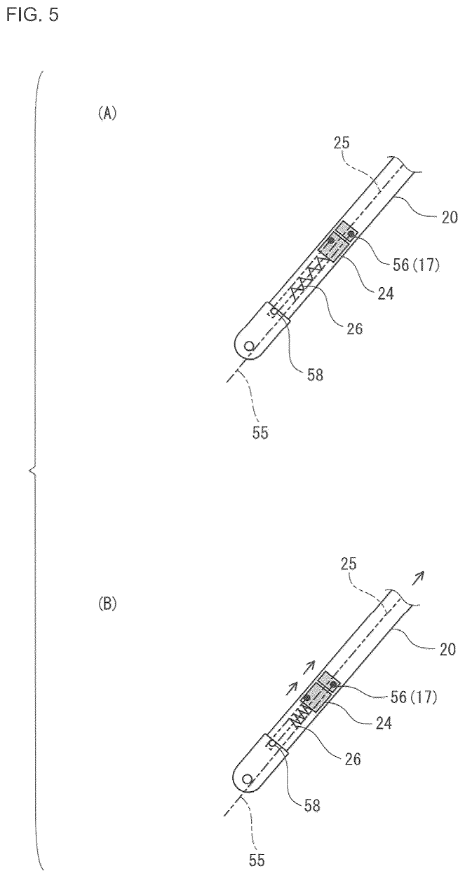

As shown in FIG. 5, the rear-wheel-side displacement member 56 is located above the drive member 24 of the operation mechanism 22 described later. The relationship between the rear-wheel-side displacement member 56 and the drive member 24 will be described later. From the perspective of improving operation stability, the rear-wheel-side displacement member 56 may be provided with a biasing member, such as a spring, that biases the rear-wheel-side displacement member 56 downward.

As described above, the operation mechanism 22 is provided on top of the push bar 20 that is switchable between the front-facing position (FIG. 1(A)) and the rear-facing position (FIG. 1(B)). The operation mechanism 22 is configured to operate the rear-wheel-side displacement member 56 to switch it from the first state (the lock position of the rear-wheel caster lock member 46) to the second state (the unlock position of the rear-wheel caster lock member 46) when the push bar 20 is in the front-facing position. The operation mechanism 22 is also configured to operate the front-wheel-side displacement member 52 to switch it from the first state (the lock position of the front-wheel caster lock member 36) to the second state (the unlock position of the front-wheel caster lock member 36) when the push bar 20 is in the rear-facing position. As used herein, the expression “configured to operate” is intended to include not only direct operation through connection, but also indirect operation through action on the component to be operated.

As shown in FIG. 2, the operation mechanism 22 includes an operation member 23, a pulley 27, and the drive member 24. The pulley 27 is rotated by the operation member 23. The drive member 24 is connected to the pulley 27 via the operation connecting member 25 and is switched by the operating force of the operation member 23.

The operation member 23 is provided on top of the push bar 20. As an example, the operation member 23 is a pressable button. However, the operation member 23 may be a lever that can be pulled up, etc. The pulley 27 can be rotated about a rotation axis by operating the operation member 23. Specifically, as shown in FIG. 6(A), a protrusion 27a of the pulley 27 extends through an elongated hole 23a of the operation member 23. When the operation member 23 is pushed inward (upward in the figure), the protrusion 27a is also moved inward as shown in FIG. 6(B). This changes the positional relationship between the protrusion 27a and the elongated hole 23a, and the pulley 27 is rotated counterclockwise. The operation connecting member 25 is thus wound up.

The operation connecting member 25 connects the operation member 23 and the drive member 24. As shown in FIG. 5(A), the operation connecting member 25 extends past the drive member 24 to the lower end of the push bar 20 and is folded back at a shaft 58 provided at the lower end of the push bar 20. Therefore, when the operation connecting member 25 is wound up, the drive member 24 is moved downward as shown in FIG. 5(B). Like the front-wheel connecting member 51 and the rear-wheel connecting member 55, the operation connecting member 25 is a bendable elongated metal member such as a wire.

The drive member 24 is biased upward by a third biasing member 26. The third biasing member 26 is, for example, a spring. The biasing force of the third biasing member 26 is greater than the biasing force of the rear-wheel first biasing member 47 and the biasing force of the front-wheel first biasing member 37. From the above, the biasing forces of the biasing members provided in the stroller 1 have the following relationship.

(front-wheel first biasing member 37=rear-wheel first biasing member 47)<(front-wheel second biasing member 38=rear-wheel second biasing member 48)<third biasing member26

As shown in FIG. 7, the drive member 24 is provided on the push bar 20. As shown in FIG. 7, the drive member 24 is located below the front-wheel-side displacement member 52 and is in contact with the front-wheel-side displacement member 52 in the up-down direction. The drive member 24 is biased upward by the third biasing member 26. The drive member 24 is connected to the operation member 23 via the operation connecting member 25. Therefore, the drive member 24 can be switched between a first state (upper state: FIGS. 2, 7) and a second state (lower state: FIGS. 3, 8) by operating the operation member 23. The first state is the state where the drive member 24 is located in an upper position, and the second state is the state where the drive member 24 is located in a lower position.

As shown in FIG. 2, when the push bar 20 is in the front-facing position and the operation member 23 is not operated, the drive member 24 is in the first state due to the biasing force of the third biasing member 26. Therefore, the rear-wheel-side displacement member 56 is moved upward. As described above, the biasing force of the third biasing member 26 of the operation mechanism 22 is greater than the biasing force of the rear-wheel second biasing member 48. Therefore, the biasing force of the second biasing member 48 that biases the rear-wheel moving member 45 downward is counteracted by the biasing force of the third biasing member 26. As a result, the rear-wheel moving member 45 is pulled up by the rear-wheel connecting member 55 against the biasing force of the rear-wheel second biasing member 48. With this movement of the rear-wheel moving member 45, the rear-wheel caster lock member 46 is moved upward by the biasing force of the rear-wheel first biasing member 47. The rear-wheel caster lock member 46 is thus located in the lock position.

As shown in FIG. 3, when the push bar 20 is in the front-facing position and the operation member 23 is operated, the drive member 24 is moved downward against the biasing force of the third biasing member 26. Therefore, the rear-wheel displacement member 56 is moved downward. As described above, when the drive member 24 is moved downward, the third biasing member 26 contracts, and the biasing force of the third biasing member 26 is counteracted. The rear-wheel displacement member 56 is therefore moved downward. This allows the biasing force of the rear-wheel second biasing member 48 to act effectively. As a result, the rear-wheel moving member 45 is moved downward. As described above, the biasing force of the rear-wheel second biasing member 48 is greater than the biasing force of the rear-wheel first biasing member 47. Therefore, the rear-wheel moving member 45 moves the rear-wheel caster lock member 46 to the unlock position. Although the drive member 24 is not directly connected to the rear-wheel-side displacement member 56, the drive member 24 is indirectly operated by the operation mechanism 22 in this manner.

The operation mechanism 22, the front-wheel-side displacement member 52, and the rear-wheel side displacement member 56 are members that actuate the caster lock members 36, 46. The operation mechanism 22, the front-wheel-side displacement member 52, and the rear-wheel side displacement member 56 actuate the caster lock members 36, 46 to switch them between a first state corresponding to the lock position of the caster lock members 36, 46 and a second state corresponding to the unlock position of the caster lock members 36, 46. Therefore, the operation mechanism 22, the front-wheel-side displacement member 52, and the rear-wheel side displacement member 56 are also collectively referred to as “actuation mechanism.” Each of the operation mechanism 22, the front-wheel-side displacement member 52, and the rear-wheel side displacement member 56 that constitute the actuation mechanism may actuate the caster members 36, 46 to switch them between the first state and the second state, or at least one of the operation mechanism 22, the front-wheel-side displacement member 52, and the rear-wheel side displacement member 56 that constitute the actuation mechanism may be configured to actuate the caster members 36, 46 to switch them between the first state and the second state.

### Operation

The operation of restricting or permitting pivoting of the caster mechanisms 30, 40 of the stroller 1 of the present embodiment will be described with reference to FIGS. 2, 3, 7, and 8. FIGS. 2 and 3 show the push bar 20 in the front-facing position. FIG. 2 shows a state in which the operation mechanism 22 is not operated, and FIG. 3 shows a state in which the operation mechanism 22 is operated. FIGS. 7 and 8 show the push bar 20 is the rear-facing position. FIG. 7 shows a state in which the operation mechanism 22 is not operated, and FIG. 8 shows a state in which the operation mechanism 22 is operated.

First, the operation when the push bar 20 is in the front-facing position will be described with reference to FIGS. 2 and 3. As shown in FIG. 2, when the push bar 20 is in the front-facing position, the front-wheel caster mechanism 30 is allowed to pivot around its pivot axis, and the rear-wheel caster mechanism 40 is not allowed to pivot around its pivot axis. In the front-wheel caster mechanism 30, the biasing force of the front-wheel second biasing member 38 is greater than the biasing force of the front-wheel first biasing member 37. Therefore, the biasing force of the front-wheel first biasing member 37 is counteracted, and the front-wheel moving member 35 is biased downward by the biasing force of the front-wheel second biasing member 38. Accordingly, the front-wheel caster lock member 36 is located in the unlock position (lower position).

Regarding the rear-wheel caster mechanism 40, the drive member 24 of the operation mechanism 22 on the push bar 20 and the rear-wheel-side displacement member 56 on the armrest support member 17 are in contact with each other in the up-down direction. Since the drive member 24 is biased upward by the third biasing member 26, the rear-wheel-side displacement member 56 is also located in an upper position. Since the rear-wheel-side displacement member 56 is connected to the rear-wheel moving member 45 via the rear-wheel connecting member 55, the rear-wheel moving member 45 is located at the first position (upper position). At this time, the rear-wheel second biasing member 48 biases the rear-wheel moving member 45 toward the second position (lower position), but the biasing force of the rear-wheel second biasing member 48 is smaller than the biasing force of the third biasing member 26. Therefore, the downward biasing force of the rear-wheel second biasing member 48 is counteracted by the upward biasing force of the third biasing member 26, and the rear-wheel moving member 45 is located in the upper position. Due to the upward biasing force of the rear-wheel first biasing member 47, the rear-wheel caster lock member 46 is moved to the upper position where the rear-wheel caster lock member 46 contacts the rear-wheel moving member 45. The rear-wheel caster lock member 46 is thus located in the lock position (upper position).

As shown in FIG. 3, to allow not only the front-wheel caster mechanism 30 but also the rear-wheel caster mechanism 40 to pivot about their pivot axes and attain the drift state when the push bar 20 is in the front-facing position, the operation member 23 is operated. Specifically, the operation member 23 is pushed upward in the figure to rotate the pulley 27 counterclockwise, causing the pulley 27 to wind up the operation connecting member 25. As shown particularly in FIG. 5(A), the operation connecting member 25 extends downward and is then folded back upward at the shaft 58 located below the rear-wheel-side displacement member 56. Therefore, when the operation connecting member 25 is wound up, the drive member 24 is moved downward. Specifically, the drive member 24 connected to the operation connecting member 25 is moved downward against the biasing force of the third biasing member 26, and the rear-wheel-side displacement member 56 is also moved downward. In other words, the biasing force of the third biasing member 26 is counteracted.

As shown in FIG. 3, since the rear-wheel-side displacement member 56 is connected to the rear-wheel moving member 45 via the rear-wheel connecting member 55, the rear-wheel moving member 45 is moved to the lower position. As described above, the biasing force of the third biasing member 26 is counteracted. Therefore, the rear-wheel moving member 45 is biased to the lower position by the downward biasing force of the rear-wheel second biasing member 48. At this time, the rear-wheel caster lock member 46 is biased upward by the upward biasing force of the rear-wheel first biasing member 47. However, since the biasing force of the rear-wheel second biasing member 48 is greater than the biasing force of the rear-wheel first biasing member 47, the biasing force of the rear-wheel second biasing member 48 counteracts the biasing force of the rear-wheel first biasing member 47. The rear-wheel caster lock member 46 is therefore moved to the unlock position (lower position) by the rear-wheel moving member 45. As described above, by operating the operation mechanism 22, not only the front-wheel caster mechanism 30 but also the rear-wheel caster mechanism 40 are allowed to pivot around their pivot axes, and the drift state can thus be attained.

Next, the operation when the push bar 20 is in the rear-facing position will be described with reference to FIGS. 7 and 8. As shown in FIG. 7, when the push bar 20 is in the rear-facing position, the rear-wheel caster mechanism 40 is allowed to pivot around its pivot axis, and the front-wheel caster mechanism 30 is not allowed to pivot around its pivot axis. In the rear-wheel caster mechanism 40, the biasing force of the rear-wheel second biasing member 48 is greater than the biasing force of the rear-wheel first biasing member 47. Therefore, the biasing force of the rear-wheel second biasing member 48 counteracts the biasing force of the rear-wheel first biasing member 47, and the rear-wheel moving member 45 is biased downward by the biasing force of the rear-wheel second biasing member 48. Accordingly, the rear-wheel caster lock member 46 is located in the unlock position (lower position).

Focusing on the front leg 11, the front-wheel-side displacement member 52 on the front leg 11 is located above the drive member 24 of the operation mechanism 22 on the push bar 20. Since the front-wheel-side displacement member 52 is connected to the front-wheel moving member 35 via the front-wheel connecting member 51, the front-wheel moving member 35 is located at the upper position. At this time, the front-wheel second biasing member 38 biases the front-wheel moving member 35 toward the lower position, but the biasing force of the front-wheel second biasing member 38 is counteracted by upward movement of the front-wheel-side displacement member 52, and the front-wheel moving member 35 is located in the upper position. Due to the upward biasing force of the front-wheel first biasing member 37, the front-wheel caster lock member 36 is moved to the upper position where the front-wheel caster lock member 36 contacts the front-wheel moving member 35. The front-wheel caster lock member 36 is thus located in the lock position (upper position).

To allow not only the rear-wheel caster mechanism 40 but also the front-wheel caster mechanism 30 to pivot about their pivot axes and attain the drift state when the push bar 20 is in the rear-facing position, the operation member 23 is operated. Specifically, as shown in FIG. 8, the operation member 23 is pushed upward in the figure to rotate the pulley 27 counterclockwise, causing the pulley 27 to wind up the operation connecting member 25. As described above, the operation connecting member 25 extends downward and is then folded back upward at the shaft 58. Therefore, when the operation connecting member 25 is wound up, the drive member 24 is moved downward. Specifically, the drive member 24 is moved downward against the biasing force of the third biasing member 26, and the front-wheel-side displacement member 56 is also moved downward.

Since the front-wheel-side displacement member 52 is connected to the front-wheel moving member 35 via the front-wheel connecting member 51, the front-wheel moving member 35 is moved to the lower position. Specifically, the front-wheel moving member 45 is moved to the lower position by the downward biasing force of the front-wheel second biasing member 38. At this time, the front-wheel caster lock member 36 is biased upward by the upward biasing force of the front-wheel first biasing member 37. However, since the biasing force of the front-wheel second biasing member 38 is greater than the biasing force of the front-wheel first biasing member 37, the biasing force of the front-wheel second biasing member 38 counteracts the biasing force of the front-wheel first biasing member 37. The front-wheel caster lock member 36 is therefore moved to the unlock position (lower position). As described above, by operating the operation mechanism 22, not only the rear-wheel caster mechanism 40 but also the front-wheel caster mechanism 30 are allowed to pivot around their pivot axes, and the drift state can thus be attained.

### Effects

In conventional strollers, an elongated lock pin that is movable in its longitudinal direction is often used to perform locking and unlocking for swiveling. Therefore, depending on the rotational position of a wheel mounting body, the elongated lock pin may contact the wall surface of an elongated hole, causing resistance between the lock pin and the wall surface of the elongated hole. As a result, unlocking for permitting swiveling may not be smoothly performed. In a case where the lock pin is disengaged (unlocking is performed) by using an operation mechanism connected to the lock pin via a wire etc., there is the following concern. If the operation mechanism is forcibly operated while resistance is present between the lock pin and the wall surface of the elongated hole, the wire may break, leading to a malfunction.

On the other hand, in the stroller of the present embodiment, the caster lock members 36, 46 are biased toward the lock position by the first biasing members 37, 47 and are moved to the lock position or the unlock position by the moving members 35, 45, respectively. Therefore, the components that transmit the operating force of the connecting members 51, 55 to the caster lock members 36, 46 are the moving members 35, 45, and the caster lock members 36, 46 are merely displaced according to the operation of the moving members 35, 45, respectively. Accordingly, the configuration of the present embodiment can improve operability in performing locking and unlocking for swiveling.

Moreover, even when the caster lock members 36, 46 come into contact with the wall surfaces of the holes 43, 44 and resistance occurs therebetween, the components that are connected to the connecting members 51, 52 are not the caster lock members 36, 46 that perform locking but the moving members 35, 45. As described above, the caster lock members 36, 46 are always biased upward with a constant force by the first biasing members 37, 47, respectively. Therefore, even when the connecting members 51, 55 are pulled upward through the operation of the operation mechanism 22, it is possible to switch the caster mechanisms 30, 40 to the unlock position after waiting until resistance between the caster lock members 36, 46 and the wall surfaces of the holes 43, 44 is no longer present. Accordingly, the connecting members 51, 55 do not break, and the caster lock members 36, 46 are not damaged. As described above, the stroller 1 of the present embodiment can improve operability in permitting pivoting of the caster mechanisms 30, 40 and can also reduce the possibility of component malfunctions.

### Second Embodiment

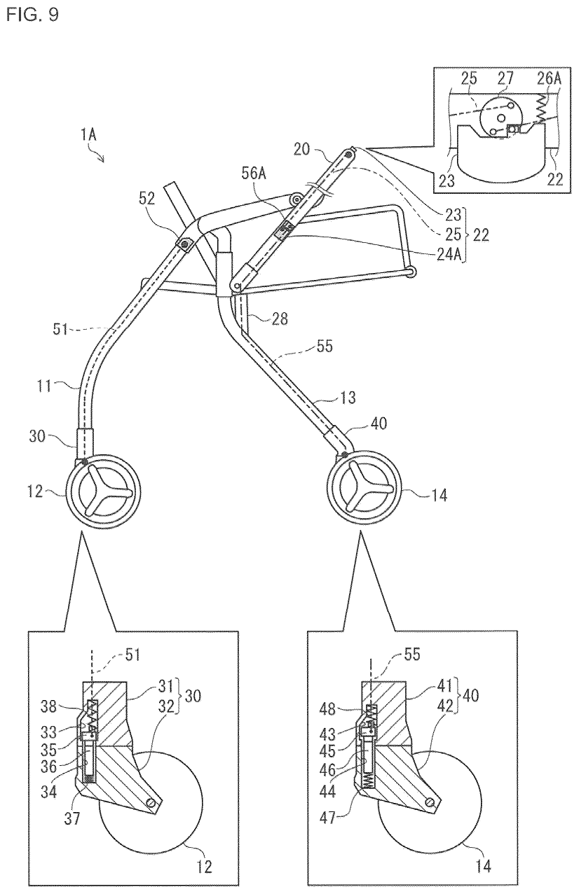

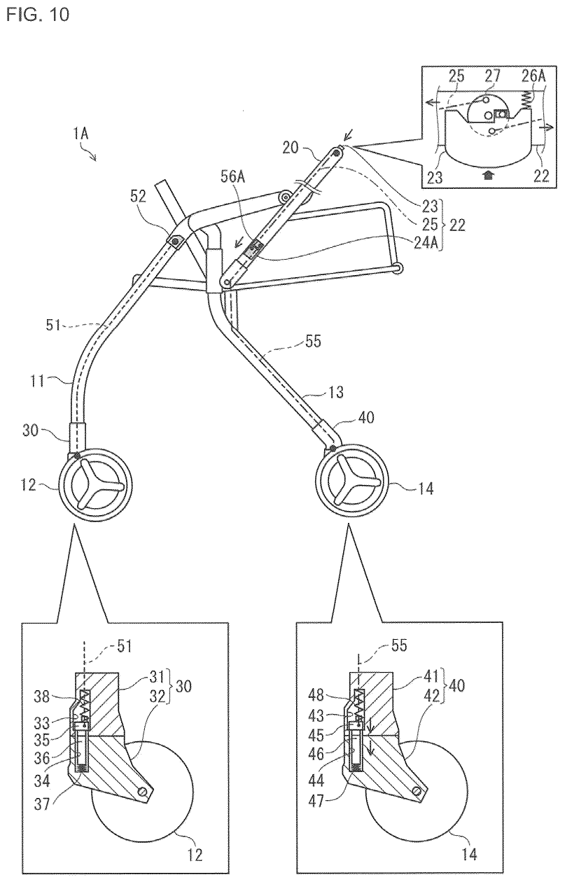

The configuration of a stroller 1A according to a second embodiment will be described with reference to FIGS. 9 and 10. The stroller 1A of the present embodiment is basically the same in configuration as the first embodiment. The major difference is the arrangement of a third biasing member 26A and a drive member 24A of the operation mechanism 22 and a rear-wheel-side displacement member 56A. Only the differences from the configuration of the first embodiment will be described in detail.

### Configurations

In the stroller 1A of the present embodiment, the drive member 24A is disposed below the rear-wheel-side displacement member 56 as in the stroller 1 of the first embodiment. However, the stroller 1A of the present embodiment is different from the stroller 1 of the first embodiment in that the operation connecting member 25 connected to the drive member 24A is not folded back and extends linearly.

In the first embodiment, the drive member 24 is provided with the third biasing member 26 and is biased upward by the third biasing member 26. However, a third biasing member 26A of the present embodiment is different from the third biasing member 26 in that the third biasing member 26A biases the operation member 23 toward a first state (state in which the operation member 23 protrudes outward). Since the operation member 23 is configured to operate the pulley 27 and is connected to the drive member 24A via the operation connecting member 25, the third biasing member 26A of the present embodiment biases the drive member 24A upward. Accordingly, as shown in FIG. 10, the drive member 24A is moved downward by operating the operation member 23 to a second state (state in which the operation member 23 is pushed inward).

In the present embodiment, the operation connecting member 25 need not be folded back like the operation connecting member 25 of the first embodiment. Therefore, a simple structure can be realized. As in the stroller 1 of the first embodiment, in the stroller 1A of the present embodiment, the front wheels 12 are locked and the rear wheels 14 are unlocked by switching the push bar 20 to the rear-facing position, and the drift state can be attained by operating the operation member 23 when the push bar 20 is in the rear-facing position.

### Third Embodiment

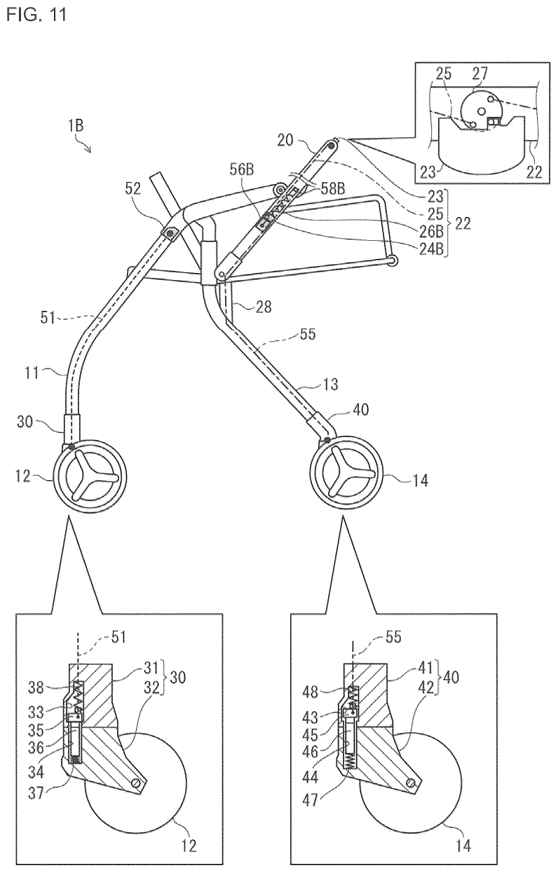

The configuration and operation of a stroller 1B according to a third embodiment will be described with reference to FIGS. 11 to 13. The stroller 1B of the present embodiment is basically the same in configuration as the first embodiment. The major difference is the arrangement of a third biasing member 26B and a drive member 24B of the operation mechanism 22 and a rear-wheel-side displacement member 56B. Only the differences from the configuration of the first embodiment will be described in detail.

### Configurations

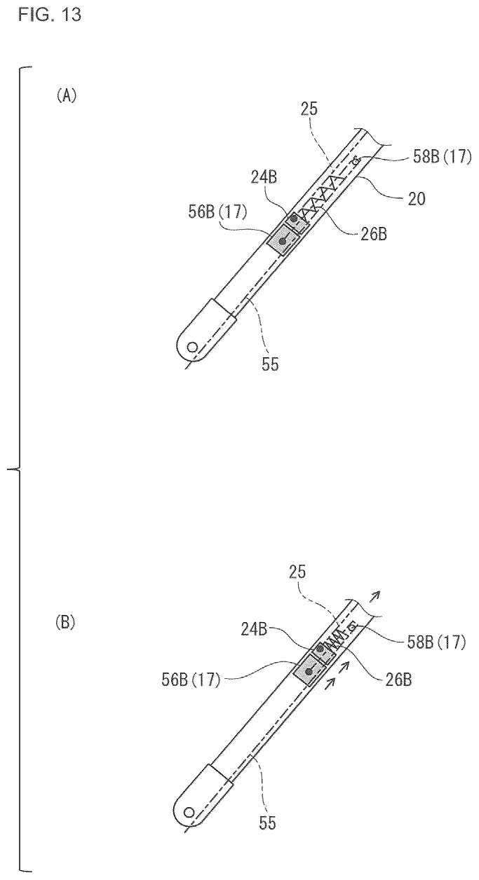

As shown particularly in FIGS. 13(A) and 13(B), the rear-wheel-side displacement member 56B of the present embodiment is connected to the rear-wheel connecting member 55, but the rear-wheel connecting member 55 is located above the rear-wheel-side displacement member 56B and folded back in the up-down direction at a shaft 58B supported by the armrest support portion 17. Specifically, the rear-wheel connecting member 55 is connected to the rear-wheel caster lock member 46 and extends upward, and is then folded back downward at the shaft 58B and connected to the rear-wheel-side displacement member 56B. The drive member 24B is located above and is in contact with the rear-wheel-side displacement member 56B. The drive member 24B is biased downward by the third biasing member 26B.

As described above, in the first embodiment, the operation connecting member 25 is folded back and the drive member 24 is biased upward by the third biasing member 26. However, in the present embodiment, the rear-wheel connecting member 55 may be folded back, and the drive member 24B may be provided so as to be biased downward by the third biasing member 26B. The positional relationships among the drive members 24, 24B, the rear-wheel-side displacement members 56, 56B, and the connecting members 25, 55 are not limited to the embodiments. These components may have any positional relationship as long as the connecting members 51, 55 are loosened through the operation of the operation member 23 so that the biasing forces of the second biasing members 38, 48 act effectively and the rear-wheel moving members 35, 45 are moved downward by these biasing forces.

### Operation

FIGS. 11 and 13(A) show a state in which the operation member 23 is not operated. As shown in these figures, when the operation member 23 is not operated, the drive member 24B is located at a lower position due to the biasing force of the third biasing member 26B and therefore the rear-wheel-side displacement member 56B is also located at a lower position. The rear-wheel-side displacement member 56B is connected to the rear-wheel connecting member 55. As shown particularly in FIG. 13(A), the rear-wheel connecting member 55 extends upward and is then folded back downward at the shaft 58B located above the rear-wheel-side displacement member 56B. When the rear-wheel-side displacement member 56B is located at the lower position, it means that the rear-wheel connecting member 55 is being pulled upward. Therefore, as shown in FIG. 11, the rear-wheel moving member 45 connected to the rear-wheel connecting member 55 is moved upward against the biasing force of the rear-wheel second biasing member 48. As a result, the rear-wheel caster lock member 46 is located in the lock position (upper position).

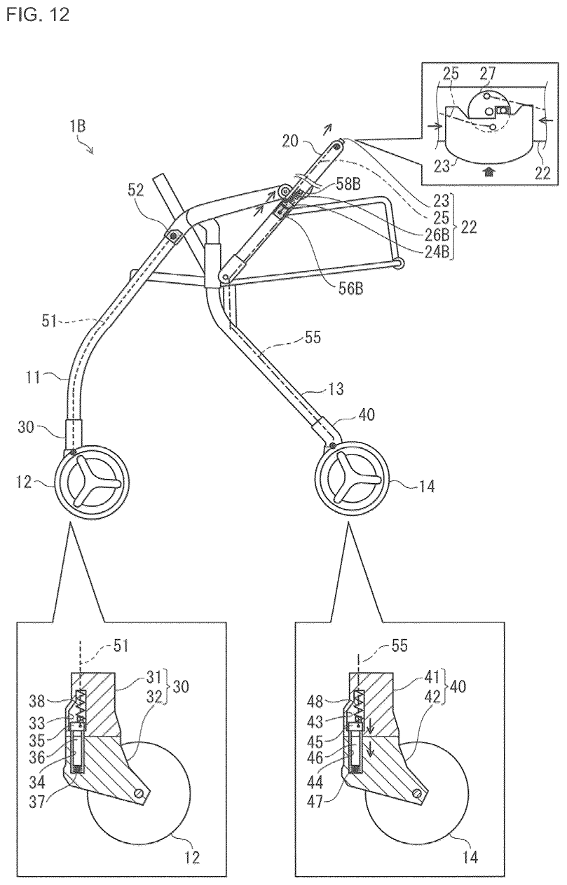

FIGS. 12 and 13(B) show a state in which the operation member 23 is operated. As shown in these figures, when the operation member 23 is operated, the pulley 27 is rotated and the operation connecting member 25 is pulled upward. As a result, the rear-wheel-side displacement member 56B is also moved to the upper position against the biasing force of the third biasing member 26B. The rear-wheel-side displacement member 56B is connected to the rear-wheel connecting member 55. As shown particularly in FIG. 13(A), the rear-wheel connecting member 55 extends upward and is then folded back downward at the shaft 58B located above the rear-wheel-side displacement member 56B. When the rear-wheel-side displacement member 56B is located at the upper position, it means that the rear-wheel connecting member 55 is being loosened. Therefore, the rear-wheel moving member 45 connected to the rear-wheel connecting member 55 is moved downward by the biasing force of the rear-wheel second biasing member 48. As a result, the rear-wheel caster lock member 46 is located at the unlock position (lower position).

### Fourth Embodiment

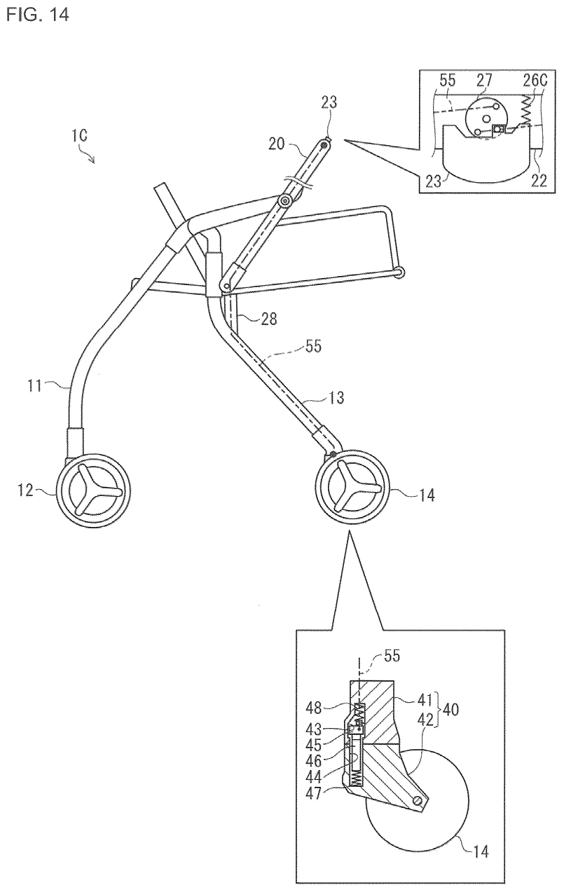

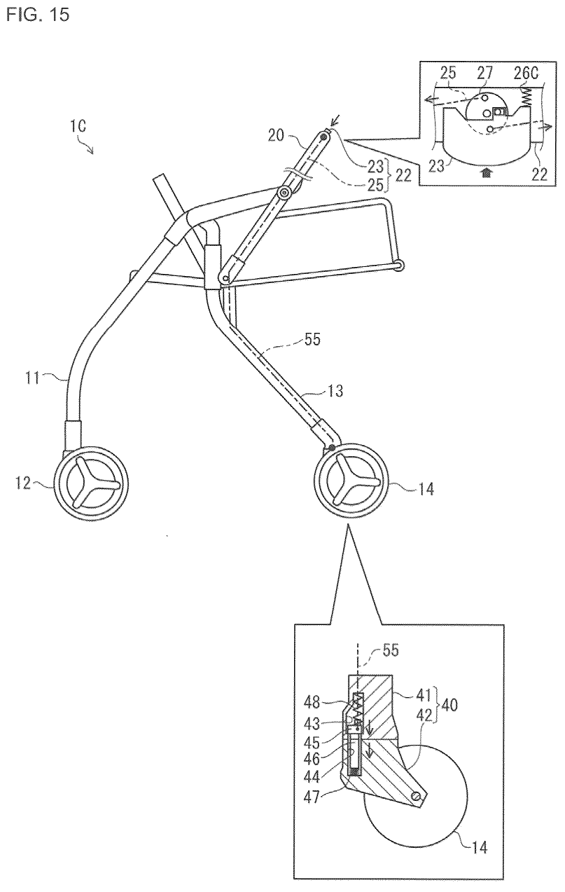

The configuration and operation of a stroller 1C according to a fourth embodiment will be described with reference to FIGS. 14 and 15. The stroller 1C of the present embodiment is basically the same in configuration as the first embodiment. The stroller 1C of the present embodiment is different from the first embodiment in that the push bar 20 is fixed in the front-facing position, the displacement members are not provided, and the pulley 27 of the operation member 23 is directly connected to the rear-wheel moving member 45 for the rear wheel 14. Only the differences from the configuration of the first embodiment will be described in detail.

### Configurations

In the stroller 1C of the present embodiment, both the front wheels 12 and the rear wheels 14 are caster wheels, but only the rear wheels 14 are provided with the caster lock member 46 that restricts pivoting around a pivot axis. The stroller 1C illustratively shown in FIGS. 14 and 15 is foldable.

The stroller 1C shown in FIGS. 14 and 15 includes at least the rear-wheel caster mechanism 40, the rear-wheel moving member 45, the rear-wheel first biasing member 47, the rear-wheel caster lock member 46, the rear-wheel second biasing member 48, and the operation member 23 on the push bar 20, and the pulley 27. These components are described regarding the stroller of the first embodiment.

As in the second embodiment, the operation mechanism 22 is provided with a third biasing member 26C that biases the operation member 23 to the first state (state in which the operation member 23 protrudes outward). The rear-wheel moving member 45 of the present embodiment is operated by the operation member 23 of the operation mechanism 22. Specifically, the rear-wheel moving member 45 and the pulley 27 of the operation mechanism 22 are connected via the rear-wheel connecting member 55.

### Operation

FIG. 14 shows a state in which the operation mechanism 22 is not operated. As shown in the figure, when the operation member 23 is not operated, the rear-wheel connecting member 55 is pulled upward by the biasing force of the third biasing member 26C, and the rear-wheel moving member 45 connected to the rear-wheel connecting member 55 is moved upward against the biasing force of the rear-wheel second biasing member 48. Accordingly, the rear-wheel caster lock member 46 is located in the lock position.

FIG. 15 shows a state in which the operation mechanism 22 is operated. As shown in the figure, when the operation member 23 is operated against the biasing force of the third biasing member 26C, the pulley 27 is rotated and the operation connecting member 25 is fed out. Therefore, the rear-wheel moving member 45 connected to the rear-wheel connecting member 55 is moved downward by the biasing force of the rear-wheel second biasing member 48. Accordingly, the rear-wheel caster lock member 46 is located in the unlock position.

In the stroller 1C of the present embodiment, the push bar 20 is fixed in the front-facing position and the stroller 1C is foldable. However, the push bar 20 may be switchable between the front-facing position and the rear-facing position, and the stroller 1C may be non-foldable. A non-foldable stroller is not provided with the reversal bracket 28. Therefore, when the stroller 1C is non-foldable, the rear-wheel connecting member 55 may pass through the rear leg 13 and the lower end portion of the push bar 20 in this order, and the rear-wheel-side displacement member 56 may be provided at the lower end of the push bar 20.

### Fifth Embodiment

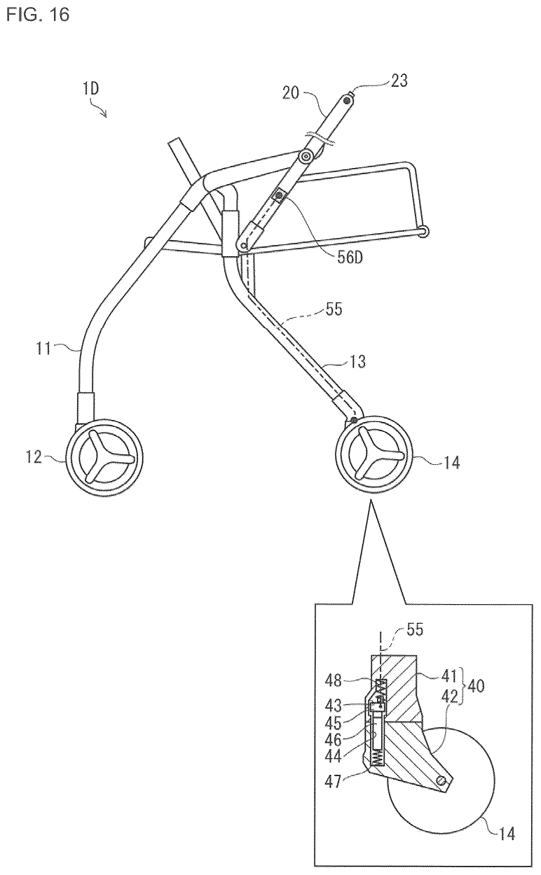

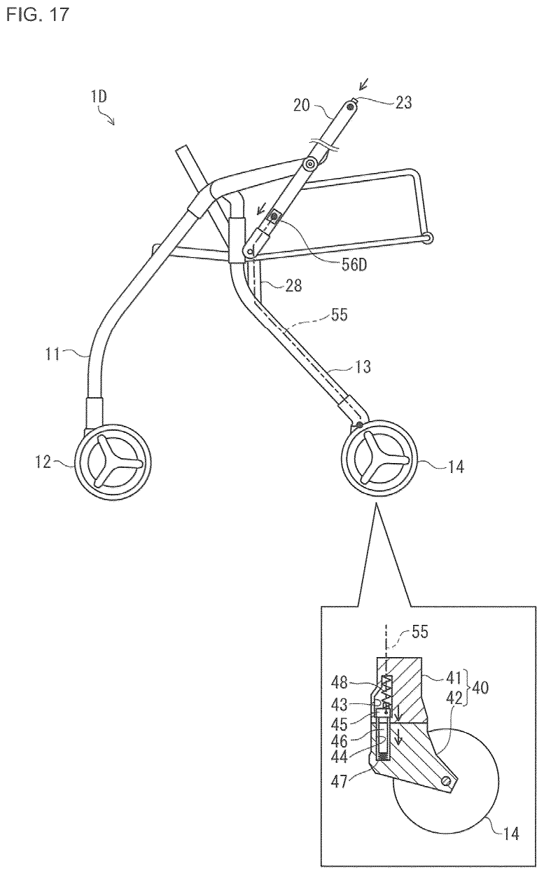

The configuration and operation of a stroller 1D according to a fifth embodiment will be described with reference to FIGS. 16 and 17. As in the fourth embodiment, in the stroller 1D of the present embodiment, the push bar 20 is fixed in the front-facing position. The stroller 1D of the present embodiment is basically the same in configuration as the fourth embodiment. The stroller 1D of the present embodiment is different from the fourth embodiment in that a rear-wheel-side displacement member 56D is operated instead of operating the operation member 23 on the push bar 20. Only the differences from the configuration of the fourth embodiment will be described in detail.

In the stroller 1D of the present embodiment, the rear-wheel-side displacement member 56D is provided on the push bar 20. The rear-wheel-side displacement member 56D is, for example, a member that protrudes in the width direction on the push bar 20. The rear-wheel-side displacement member 56D may be configured such that it can be moved up and down along the push bar 20, or may be configured such that it can be manually moved upward only when it is desired to allow the rear-wheel caster mechanism 40 to pivot around its pivot axis. The rear-wheel-side displacement member 56D includes a holding portion (not shown) that allows the rear-wheel-side displacement member 56D to be held in the upper position shown in FIG. 16. The holding portion may be a mechanism that holds the rear-wheel-side displacement member 56D in the upper position. For example, the holding portion may be an engaging portion such as a hook, a protrusion, or a recess.

### Operation

FIG. 16 shows a state in which the rear-wheel-side displacement member 56D is not operated. As shown in the figure, when the rear-wheel displacement member 56D is not operated, the rear-wheel-side displacement member 56D is held in the upper position by the holding portion, not shown. Since the rear-wheel-side displacement member 56D is connected to the rear-wheel moving member 45 via the rear-wheel connecting member 55, the rear-wheel moving member 45 is moved upward against the biasing force of the rear-wheel second biasing member 48. Accordingly, the rear-wheel caster lock member 46 is located in the lock position.

FIG. 17 shows a state in which the rear-wheel-side displacement member 56D is operated. As shown in the figure, when the holding portion is disengaged, the rear-wheel moving member 45 connected to the rear-wheel connecting member 55 is moved downward by the biasing force of the rear-wheel second biasing member 48. Accordingly, the rear-wheel caster lock member 46 is located in the unlock position.

In the stroller 1D of the present embodiment, only the rear wheels 14 are provided with the rear-wheel moving member 45, the rear-wheel caster lock member 46, and the rear-wheel-side displacement member 56D. However, the front wheels 12 may also be provided with the front-wheel moving member 35, the front-wheel caster lock member 36, and the front-wheel-side displacement member 52.

### Sixth Embodiment

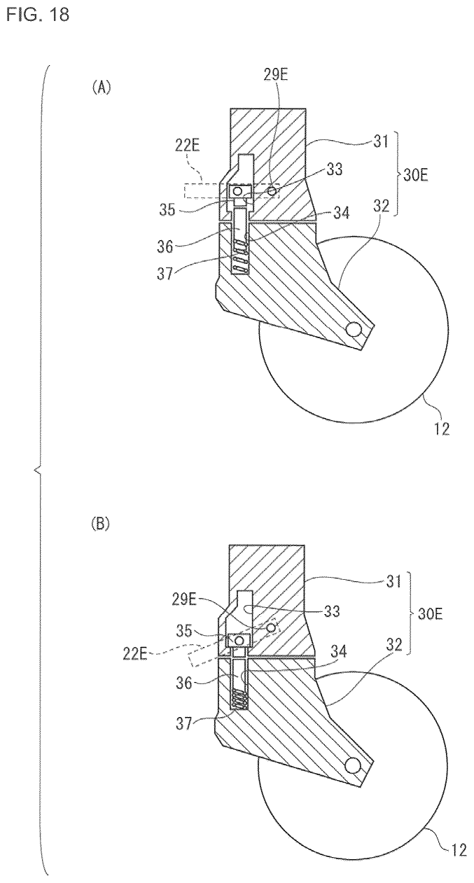

The configuration and operation of a stroller according to a sixth embodiment will be described with reference to FIG. 18. The stroller of the present embodiment is different from the above embodiments in the caster mechanism. Since the caster mechanisms for the front wheels 12 and the rear wheels 14 have substantially the same configuration, a front-wheel caster mechanism 30E will be described. The front-wheel caster mechanism 30E of the present embodiment is basically the same in configuration as the front-wheel caster mechanism 30 of the above embodiments. The major difference is that an operation mechanism 22E is directly provided on the front-wheel moving member 35. In FIGS. 18(A) and 18(B), the operation mechanism 22E is shown by a dashed line. Only the differences from the configuration of the fourth embodiment will be described in detail.

As described in the first embodiment, the front-wheel caster mechanism 30E of the present embodiment includes the front-wheel moving member 35, the front-wheel caster lock member 36, and the front-wheel first biasing member 37. The operation mechanism 22E is fixed to the front-wheel moving member 35. The operation mechanism 22E is pivotable via a pivot shaft 29E. The operation mechanism 22E may be, for example, a pedal that is operable by foot. The front-wheel moving member 35 can therefore be displaced between the first state and the second state by pivoting the operation mechanism 22E up and down. As a result, the front-wheel caster lock member 36 can be displaced between the lock position and the unlock position.

The operation mechanism 22E includes a holding portion that allows the operation mechanism 22E to be held in the position shown in FIG. 18(A). For example, the holding portion may be an engaging portion such as a hook, a protrusion, or a recess. The front-wheel first biasing member 37 is disposed between the front-wheel caster lock member 36 and the second hole 34, and biases the front-wheel caster lock member 36 upward. The front-wheel second biasing member provided in the first embodiment is not provided in the present embodiment. However, this front-wheel second biasing member may be provided for operation stability.

### Operation

FIG. 18(A) shows a state in which the operation mechanism 22E is not operated. As shown in the figure, when the operation mechanism 22E is not operated, the front-wheel moving member 35 is held in the upper position by the holding portion, not shown. Since the front-wheel caster lock member 36 is biased upward by the biasing force of the front-wheel first biasing member 37, the front-wheel caster lock member 36 contacts the front-wheel moving member 35. Accordingly, the front-wheel caster lock member 36 is located in the lock position.

FIG. 18(B) shows a state in which the operation mechanism 22E is operated. As shown in the figure, to operate the operation mechanism 22E, the holding portion is disengaged, the operation mechanism 22E is pushed and pivoted downward around the pivot shaft 29E. As a result, the front-wheel moving member 35 is moved downward against the biasing force of the front-wheel first biasing member 37. Accordingly, the rear-wheel caster lock member 46 is located in the unlock position

### Modifications of Embodiments

In all of the embodiments, all of the front wheels 12 and the rear wheels 14 are caster wheels. However, it is sufficient if at least one of the four wheels is a caster wheel, and the remaining three wheels may be ordinary wheels that do not pivot around a vertical axis. Alternatively, at least the pair of front wheels 12 or the pair of rear wheels 14 may be caster wheels.

In all of the embodiments except the sixth embodiment, the second biasing members 38, 48 and the third biasing member 26 are provided. In the embodiments other than the fifth and sixth embodiments, the second biasing members 38, 48 are provided. However, these biasing members are provided to stabilize the operation of the caster lock members 36, 46, and it is sufficient if at least the first biasing members 37, 47 are provided.

In the above embodiments, the front-wheel caster lock member 36 is provided in the front-wheel caster pivot member 32, and the rear-wheel caster lock member 46 is provided in the rear-wheel caster pivot member 42. However, the wheel caster lock member may be provided in the front-wheel caster holding member 31 or the rear-wheel caster holding member 41. The wheel caster member may be provided at any position as long as it is provided in the front-wheel caster member 30 or the rear-wheel caster member 40.

In the above embodiments, the moving members 35, 45 are located in the first holes 33, 43 of the caster holding members 31, 41 and move up and down. However, it is sufficient if the moving members 35, 45 are provided in the caster holding members 31, 41 and are movable between the first position and the second position. The moving members 35, 45 may not be disposed in the first holes 33, 43.

As an example, the caster lock members 36, 46 of the above embodiment are described as pins that are long in the up-down direction. However, the shape of the caster lock members 36, 46 is not particularly limited as long as they restrict pivoting of the caster pivot members 32, 42 when in the lock position and permit pivoting of the caster pivot members, 32, 42 when in the unlock position. For example, the caster lock members 36, 46 may be annular members that are disposed in a boundary region between the caster holding member 31 and the caster pivot member 32 and a boundary region between the caster holding member 41 and the caster pivot member 42, respectively.

In the above embodiments, the front-wheel-side displacement member 52 is provided on the front leg 11, and the rear-wheel-side displacement member 56 is provided on the rear leg 13. However, the front-wheel-side displacement member 52 and the rear-wheel-side displacement member 56 may be provided at any positions as long as they are provided on the vehicle body frame 10. Specifically, the front-wheel-side displacement member 52 may be provided on, for example, the rear leg 13.

In the above embodiments, the push bar 20 is slidable between the front-facing position and the rear-facing position via the swing shafts 21. However, the push bar 20 need not necessarily be slidable. For example, the push bar 20 may be detachable from the body frame 10, and may be detached from the body frame 10 and reattached thereto when switching the push bar 20 between the front-facing position and the rear-facing position. That is, the push bar 20 may be of any type as long as the push bar 20 is switchable between the front-facing position and the rear-facing position, and how to perform switching is not particularly limited.

Although several embodiments have been described in the present specification, configurations of these embodiments may be extracted and combined as appropriate.

While the embodiments of the present invention have been described above with reference to the drawings, the present invention is not limited to them. Various changes and modifications may be made to the illustrated embodiments without departing from the spirit and scope of the invention.

1. A wheeled childcare device comprising:
a body frame including a front leg and a rear leg;
a caster mechanism including a caster holding member and a caster pivot member and configured to allow a front wheel or a rear wheel to swivel, the caster holding member being provided at a lower end of the front leg or the rear leg, the caster pivot member being held by the caster holding member so as to be pivotable around a pivot axis extending in an up-down direction, and the caster pivot member supporting the front wheel or the rear wheel via a shaft;
a caster lock member provided in the caster mechanism and configured to restrict pivoting of the caster pivot member when the caster lock member is in a lock position and to permit the pivoting of the caster pivot member when the caster lock member is in an unlock position;
a first biasing member configured to bias the caster lock member toward the lock position; and
a moving member provided in the caster holding member and movable between a first position and a second position, the first position being a position in which the caster lock member is moved to the lock position by a biasing force of the first biasing member, and the second position being a position in which the biasing force of the first biasing member is counteracted and the caster lock member is moved to the unlock position.

2. The wheeled childcare device according to claim 1, wherein
the moving member is configured to push the caster lock member to the unlock position when the moving member is in the second position.

3. The wheeled childcare device according to claim 1, further comprising:
a second biasing member configured to bias the moving member toward the second position, wherein
a biasing force of the second biasing member is greater than the biasing force of the first biasing member.

4. The wheeled childcare device according to claim 3, wherein
a biasing direction of the first biasing member is opposite to a biasing force of the second biasing member.

5. The wheeled childcare device according to claim 4, further comprising:
an actuation mechanism connected to the moving member and configured to actuate the moving member to switch between a first state and a second state, the first state corresponding to the lock position of the caster lock member, and the second state corresponding to the unlock position of the caster lock member.

6. The wheeled childcare device according to claim 5, further comprising:
a connecting member connecting the moving member and the actuation mechanism.

7. The wheeled childcare device according to claim 5, wherein
the body frame further includes a push bar, and
the actuation mechanism includes an operation mechanism provided on the push bar and configured to operate the moving member to switch the moving member from the first state to the second state.

8. The wheeled childcare device according to claim 6, wherein
the actuation mechanism includes a displacement member provided on the body frame and connected to the moving member via the connecting member, the displacement member being configured to be displaced between the first state and the second state.

9. The wheeled childcare device according to claim 8, wherein
the actuation mechanism further includes a third biasing member configured to bias the displacement member toward the first state, and
a biasing force of the third biasing member is greater than the biasing force of the second biasing member.

10. The wheeled childcare device according to claim 9, wherein
the body frame further includes a push bar, and
the actuation mechanism includes an operation mechanism provided on the push bar and configured to operate the displacement member to switch the displacement member from the first state to the second state.

11. The wheeled childcare device according to claim 10, wherein
the operation mechanism includes an operation member and a drive member, the drive member being connected to the operation member and configured to be switched between the first state and the second state by an operating force of the operation member.
